(19) United States
(12) Patent Application Publication
(10) Pub. No.: US 2026/0038287 A1
(43) Pub. Date: Feb. 5, 2026

(54) TRANSFER METHOD FOR COMPLETE ANNOTATED DATA AND ELECTRONIC APPARATUS

(71) Applicant: ASUSTeK COMPUTER INC., Taipei (TW)

(72) Inventors: Shu-Chiao LIAO, Taipei (TW); Hong-Ru SHEN, Taipei (TW); Shin-Ning GUO, Taipei (TW); Guan-Ting CHEN, Taipei (TW); Chien-Yi WANG, Taipei (TW)

(21) Appl. No.: 19/188,235

(22) Filed: Apr. 24, 2025

(30) Foreign Application Priority Data
Jul. 31, 2024 (TW) 113128621

(51) Int. Cl. G06V 20/70

(52) U.S. Cl. CPC G06V 20/70

(57) ABSTRACT

A transfer method for complete annotated data and an electronic apparatus are provided. The electronic apparatus is configured to perform the transfer method for complete annotated data. The transfer method for complete annotated data includes: performing image annotation on a plurality of pieces of image data to obtain annotated data, where the annotated data includes an attribute feature and a tag range; inputting the image data and the annotated data into a first deep learning model to perform training to generate model weight information; storing the model weight information in a specific file format as a model weight file; and transferring the model weight file to an external apparatus for the external apparatus to use the model weight file.

### CROSS-REFERENCE TO RELATED APPLICATION

This application claims the priority benefit of Taiwan Application Serial No. 113128621, filed on Jul. 31, 2024. The entirety of the above-mentioned patent application is hereby incorporated by reference herein and made a part of specification.

### BACKGROUND OF THE INVENTION

### Field of the Invention

The disclosure relates to a transfer method for complete annotated data and an electronic apparatus for performing a transfer method for complete annotated data.

### Description of the Related Art

Before a deep learning model is used to perform training, sample data is generally required to perform an operation of image annotation, an image category and a location are recorded through a bounding box or pixel coordinates, and annotated data is sent into a model for training. The operation of annotation is usually performed manually or with the assistance of conventional image pre-processing to perform box selection.

To transfer a tag result to another apparatus for use, a conventional manner is to store annotated results (including an image and a tag) in a specific file format, such as an XML file, and then transfer the annotated results to another apparatus by copying or importing. Such a transfer operation is only transfer of the annotated data, and does not include the transfer of annotated image features. If other image tags are to be added, the operation of image annotation needs to be performed again.

### BRIEF SUMMARY OF THE INVENTION

The disclosure provides a transfer method for complete annotated data. The transfer method includes: performing image annotation on a plurality of pieces of image data to obtain annotated data, where the annotated data includes an attribute feature and a tag range; inputting the image data and the annotated data into a first deep learning model to perform training to generate model weight information; storing the model weight information in a specific file format as a model weight file; and transferring the model weight file from a storage apparatus to an external apparatus for the external apparatus to use the model weight file.

The disclosure further provides a transfer method for complete annotated data. The transfer method includes: performing image annotation on a plurality of pieces of image data to obtain annotated data, where the annotated data includes an attribute feature and a tag range; inputting the image data and the annotated data into a first deep learning model to perform training to generate model weight information; storing the model weight information in a specific file format as a model weight file; selecting a set of to-be-tagged images, and inferring each of the to-be-tagged images through the model weight file in the first deep learning model, to generate annotated information including the attribute feature and the tag range; storing the annotated information in a fixed file format as an annotated file; and transferring the annotated file to an external apparatus for the external apparatus to use the annotated file.

The disclosure further provides an electronic apparatus. The electronic apparatus includes a storage apparatus and a processing apparatus. The storage apparatus stores a plurality of pieces of image data and corresponding annotated data therein. The annotated data includes an attribute feature and a tag range. The processing apparatus is electrically connected to the storage apparatus and includes a first deep learning model built therein. The processing apparatus is configured to input the image data and the annotated data into the first deep learning model to perform training to generate model weight information, store the model weight information in the storage apparatus in a specific file format as a model weight file, and select to perform a first process or a second process. The first process includes: transferring the model weight file to an external apparatus for the external apparatus to use the model weight file. The second process includes: selecting a set of to-be-tagged images, inferring the to-be-tagged images through the model weight file in the first deep learning model, to generate annotated information including the attribute feature and the tag range, storing the annotated information in a fixed file format as an annotated file, and transferring the annotated file to an external apparatus for the external apparatus to use the annotated file.

Based on the above, the disclosure provides the transfer method for complete annotated data and the electronic apparatus, so as to transfer the annotated data including features after image annotation to different devices, transfer more than one type of image category features at the same time, and infer all unannotated to-be-tagged images through the annotation features to generate new annotation results. Therefore, according to the disclosure, image annotation features are transferred to different devices or storage spaces, and annotated results (annotated files) are also obtained on more images in a semi-automatic manner for direct use in model training.

### BRIEF DESCRIPTION OF THE DRAWINGS

FIG. 1 is a schematic block diagram of an electronic apparatus according to an embodiment of the disclosure.

FIG. 2 is a schematic flowchart of a transfer method for complete annotated data including a first process performed by an electronic apparatus according to an embodiment of the disclosure.

FIG. 3 is a schematic flowchart of a transfer method for complete annotated data including a second process performed by an electronic apparatus according to another embodiment of the disclosure.

### DETAILED DESCRIPTION OF THE EMBODIMENTS

Preferred embodiments are provided below for detailed description. However, the embodiments are merely used as examples for illustration, and do not limit or reduce the protection scope of the disclosure. In addition, some elements are omitted in the drawings in the embodiments to clearly show the technical features of the disclosure. The same reference numerals are used to indicate the same or similar elements in all of the drawings.

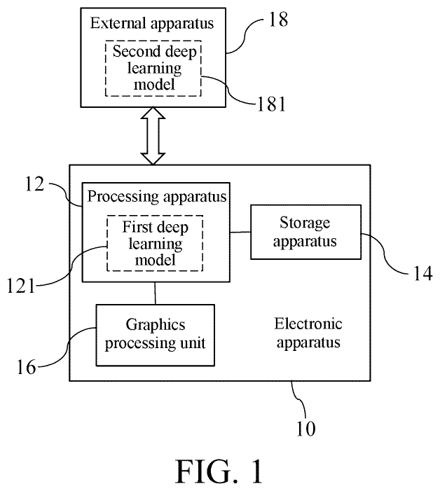

Referring to FIG. 1, an electronic apparatus 10 includes a processing apparatus 12, a storage apparatus 14, and a graphics processing unit 16. The storage apparatus 14 stores a plurality of pieces of image data and annotated data corresponding to each image data. The annotated data is in a uniform format, and includes an attribute feature and a tag range. In this embodiment, the attribute feature is a category feature and is applicable to a plurality of categories. The processing apparatus 12 is electrically connected to the storage apparatus 14, and includes a first deep learning model 121 built therein. The processing apparatus 12 reads the image data and the annotated data from the storage apparatus 14, inputs the image data and the annotated data into the first deep learning model 121 to perform training to generate model weight information with certain identification accuracy for the annotated data, and stores the model weight information in the storage apparatus 14 in a specific file format as a model weight file. After obtaining the model weight file, the processing apparatus 12 performs a first process or a second process. In the first process, the processing apparatus 12 transfers the model weight file to an external apparatus 18 in a network transmission manner or a USB external device as a transmission medium, so that the external apparatus 18 uses the model weight file. In the second process, the processing apparatus 12 selects another set of to-be-tagged images and inputs the images into the first deep learning model 121, infers each of the to-be-tagged images through the model weight file in the first deep learning model 121, to generate annotated information including the attribute feature and the tag range, and stores the annotated information in the storage apparatus 14 in a fixed file format as an annotated file. The annotated file is a transferable file with a uniform annotation format. The processing apparatus 12 then transfers the annotated file to the external apparatus 18 in a network transmission manner or a USB external device as a transmission medium, so that the external apparatus 18 uses the annotated file. In addition, the graphics processing unit 16 is electrically connected to the processing apparatus 12. When the processing apparatus 12 performs operation or training, the graphics processing unit 16 assists the processing apparatus 12 in performing related operation, so as to assist the operation through the graphics processing unit 16 and increase an overall operation speed.

In an embodiment, the external apparatus 18 further includes a second deep learning model 181 built therein. When the processing apparatus 12 selects to transfer the model weight file to the external apparatus 18 in the first process, the external apparatus 18 selects a set of to-be-tagged images, infers each of the to-be-tagged images through the model weight file in the external apparatus 18, to generate annotated information including the attribute feature and the tag range, and stores the annotated information in a fixed file format as an annotated file, so that the second deep learning model 181 in the external apparatus 18 performs training directly through the annotated file.

In an embodiment, the electronic apparatus 10 is an electronic device such as a personal computer, a notebook computer, or a tablet computer that independently performs artificial intelligence (AI) model training operation, but the disclosure is not limited thereto. Similarly, the external apparatus 18 is an electronic device such as a personal computer, a notebook computer, or a tablet computer that independently performs AT model training operation, but the disclosure is not limited thereto either.

In an embodiment, the processing apparatus 12 is a central processing unit (CPU), another general-purpose or special-purpose microprocessor, a microcontroller, a micro control unit (MCU), a digital signal processor (DSP), a programmable controller, an application specific integrated circuit (ASIC), another similar element, or a combination of the foregoing elements. The disclosure is not limited thereto.

In an embodiment, the storage apparatus 14 is any type of fixed or removable random access memory (RAM), read-only memory (ROM), flash memory, hard disk drive (HDD), solid state drive (SSD), or another similar element or a combination of the above elements, to store any model, image, data, or the like required by the processing apparatus 12, but the disclosure is not limited thereto.

In an embodiment, the first deep learning model 121 and the second deep learning model 181 are AI models of the same type or with similar functions, so that the annotated file in a uniform format generated by the electronic apparatus 10 is transferred to the external apparatus 18 for use. The first deep learning model 121 and the second deep learning model 181 are selected from an object detection model, a segmentation model, a classification model, or an anomaly detection model.

In an embodiment, the model weight file is a file for saving weight parameters. These weight parameters are learned by a model during training, and determine how the model converts input data into output results. The model weight file is usually saved in binary format, and have different specific file formats depending on a deep learning framework used. The specific file format of the model weight file is H5, weights, ckpt, pth, or the like, but the disclosure is not limited thereto. H5 is usually used in a Keras framework and a TensorFlow framework, weights is usually used in a Darknet framework, ckpt is usually used in the TensorFlow framework, and pth is usually used in a PyTorch framework, so that the model weight file is used with the above deep learning frameworks to rebuild and use the trained model.

In an embodiment, the fixed file format is a file format of Json, so that the annotated file is stored in the file format of Json, which is a reusable tag result. In an embodiment, a format of the annotated file includes image data, an annotation category name, and a range to which a tag category belongs.

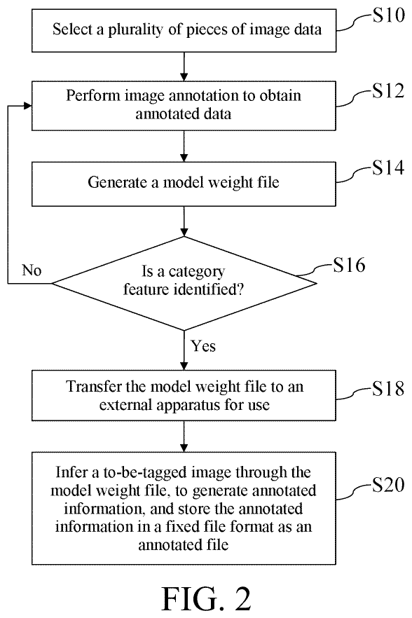

In the electronic apparatus 10, the processing apparatus 12 also performs the transfer method for complete annotated data including the first process through software. Referring to FIG. 1 and FIG. 2 together, as shown in step S10, the processing apparatus 12 selects a plurality of pieces of image data. As shown in step S12, image annotation is performed on the image data through manual annotation or automatic annotation, to obtain annotated data. As shown in step S14, the processing apparatus 12 inputs the image data and the annotated data into the first deep learning model 121 to perform training to generate model weight information, and stores the model weight information as a model weight file in a specific file format. After the model weight file is obtained, as shown in step S16, it is determined whether the first deep learning model 121 identifies the category feature (an annotation category) in the model weight file. If so, step S18 is performed. If not, which indicates that the category feature is not identified, then step S12 is performed again to re-perform image annotation. As shown in step S18, the processing apparatus 12 transfers the model weight file to the external apparatus 18 for use. As shown in step S20, the external apparatus 18 selects a set of to-be-tagged images, infers each of the to-be-tagged images through the model weight file to generate annotated information including the attribute feature and the tag range, and stores the annotated information in a fixed file format as an annotated file, so that the external apparatus 18 uses the annotated file directly, or fine-tunes or adjusts the annotated file through an annotation tool.

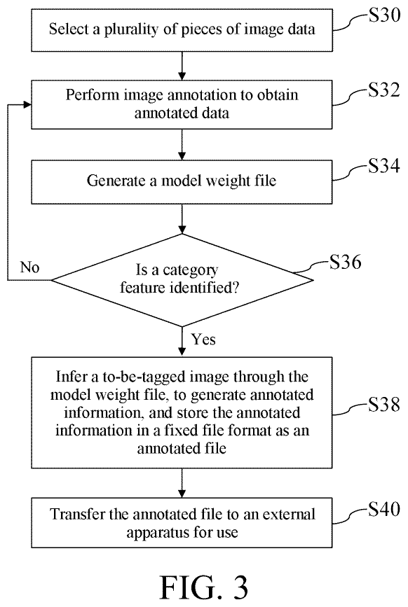

In the electronic apparatus 10, the processing apparatus 12 performs the transfer method for complete annotated data including the second process through software. Referring to FIG. 1 and FIG. 3 together, as shown in step S30, the processing apparatus 12 selects a plurality of pieces of image data. As shown in step S32, image annotation is performed on the image data through manual annotation or automatic annotation, to obtain annotated data. As shown in step S34, the processing apparatus 12 inputs the image data and the annotated data into the first deep learning model 121 to perform training to generate model weight information, and stores the model weight information as a model weight file in a specific file format. After the model weight file is obtained, as shown in step S36, it is determined whether the first deep learning model 121 identifies the category feature (an annotation category) in the model weight file. If so, step S38 is performed. If not, then step S32 is performed again to re-perform image annotation. As shown in step S38, the processing apparatus 12 selects another set of to-be-tagged images, infers each of the to-be-tagged images through the model weight file in the first deep learning model 121, to generate annotated information including the attribute feature and the tag range, and stores the annotated information in a fixed file format as an annotated file. As shown in step S40, the processing apparatus 12 transfers the annotated file to the external apparatus 18 for use, so that the external apparatus 18 directly uses the annotated file, or fine-tunes or adjusts the annotated file through an annotation tool.

Based on the above, the disclosure provides the transfer method for complete annotated data and the electronic apparatus, so as to transfer the annotated data including features after image annotation to different devices, transfer more than one type of image category features at the same time, and infer all unannotated to-be-tagged images through the annotation features to generate new annotation results. Therefore, according to the disclosure, image annotation features are transferred to different devices or storage spaces, and annotated results (annotated files) are also obtained on more images in a semi-automatic manner for direct use in model training.

The foregoing embodiments are merely for describing the technical ideas and the characteristics of the disclosure, which are intended to enable a person skilled in the art to understand and implement the content of the disclosure accordingly, and do not constitute a limitation on the patent scope of the disclosure. In other words, equivalent changes or modifications made to the spirit provided in the disclosure still fall within the scope of the patent application of the disclosure.

What is claimed is:

1. A transfer method for complete annotated data, the method comprising:
performing image annotation on a plurality of pieces of image data to obtain annotated data, wherein the annotated data comprises an attribute feature and a tag range;
inputting the image data and the annotated data into a first deep learning model to perform training to generate model weight information;
storing the model weight information in a specific file format as a model weight file; and
transferring the model weight file to an external apparatus for the external apparatus to use the model weight file.

2. The transfer method for complete annotated data according to claim 1, wherein the attribute feature is a category feature.

3. The transfer method for complete annotated data according to claim 1, wherein in the external apparatus, the method further comprises: selecting a set of to-be-tagged images, and inferring each of the to-be-tagged images through the model weight file, to generate annotated information comprising the attribute feature and the tag range; and storing the annotated information in a fixed file format as an annotated file.

4. The transfer method for complete annotated data according to claim 3, wherein the external apparatus further comprises a second deep learning model built therein, and the second deep learning model performs training directly through the annotated file.

5. The transfer method for complete annotated data according to claim 3, wherein a format of the annotated file comprises image data, an annotation category name, and a range to which a tag category belongs.

6. The transfer method for complete annotated data according to claim 4, wherein the first deep learning model and the second deep learning model are each an object detection model, a segmentation model, a classification model, or an anomaly detection model.

7. A transfer method for complete annotated data, the method comprising:
performing image annotation on a plurality of pieces of image data to obtain annotated data, wherein the annotated data comprises an attribute feature and a tag range;
inputting the image data and the annotated data into a first deep learning model to perform training to generate model weight information;
storing the model weight information in a specific file format as a model weight file;
selecting a set of to-be-tagged images, and inferring each of the to-be-tagged images through the model weight file in the first deep learning model, to generate annotated information comprising the attribute feature and the tag range;
storing the annotated information in a fixed file format as an annotated file; and
transferring the annotated file to an external apparatus for the external apparatus to use the annotated file.

8. The transfer method for complete annotated data according to claim 7, wherein the attribute feature is a category feature.

9. The transfer method for complete annotated data according to claim 7, wherein the external apparatus further comprises a second deep learning model built therein, and the second deep learning model performs training directly through the annotated file.

10. The transfer method for complete annotated data according to claim 7, wherein a format of the annotated file comprises image data, an annotation category name, and a range to which a tag category belongs.

11. The transfer method for complete annotated data according to claim 9, wherein the first deep learning model and the second deep learning model are each an object detection model, a segmentation model, a classification model, or an anomaly detection model.

12. An electronic apparatus, comprising:
a storage apparatus, storing a plurality of pieces of image data and corresponding annotated data therein, wherein the annotated data comprises an attribute feature and a tag range; and
a processing apparatus, electrically connected to the storage apparatus and comprising a first deep learning model built therein, wherein the processing apparatus is configured to input the image data and the annotated data into the first deep learning model to perform training to generate model weight information, store the model weight information in the storage apparatus in a specific file format as a model weight file, and select to perform a first process or a second process, wherein
the first process comprises: transferring the model weight file to an external apparatus for the external apparatus to use the model weight file; and
the second process comprises: selecting a set of to-be-tagged images, inferring each of the to-be-tagged images through the model weight file in the first deep learning model, to generate annotated information comprising the attribute feature and the tag range, storing the annotated information in a fixed file format as an annotated file, and transferring the annotated file to the external apparatus for the external apparatus to use the annotated file.

13. The electronic apparatus according to claim 12, wherein the external apparatus further comprises a second deep learning model built therein, and when the processing apparatus transfers the model weight file to the external apparatus in the first process, the external apparatus selects the to-be-tagged image, infers the to-be-tagged image through the model weight file to generate the annotated information comprising the attribute feature and the tag range, and stores the annotated information in a fixed file format as the annotated file, so that the second deep learning model performs training directly through the annotated file.

14. The electronic apparatus according to claim 12, wherein the attribute feature is a category feature.

15. The electronic apparatus according to claim 12, wherein a format of the annotated file comprises image data, an annotation category name, and a range to which a tag category belongs.

16. The electronic apparatus according to claim 13, wherein the first deep learning model and the second deep learning model are each an object detection model, a segmentation model, a classification model, or an anomaly detection model.

17. The electronic apparatus according to claim 12, further comprising a graphics processing unit, wherein the graphics processing unit is electrically connected to the processing apparatus, and assists the processing apparatus in performing operation.
